(19) United States
(12) Patent Application Publication
(10) Pub. No.: US 2021/0362642 A1
(43) Pub. Date: Nov. 25, 2021

(54) CARGO COVER AND STRAP SYSTEM

(71) Applicants: Eric Delangis, Wylie, TX (US); Adam Delangis, Loveland, CO (US)

(72) Inventors: Eric Delangis, Wylie, TX (US); Adam Delangis, Loveland, CO (US)

(21) Appl. No.: 17/325,081

(22) Filed: May 19, 2021

Related U.S. Application Data
(60) Provisional application No. 63/027,840, filed on May 20, 2020.

(51) Int. Cl. B60P 7/04; B60P 7/08

(52) U.S. Cl. CPC B60P 7/04; B60P 7/0823

(57) ABSTRACT

A cargo cover and strap system is provided that uses one tarp with two layers or two separate tarps, where one tarp is made of solid polyethylene waterproof material and the mesh net tarp is made of a woven fabric or woven polyethylene layer. The polyethylene tarp fits around cargo being transported in the bed of pickup truck. The mesh net is layered on top or joined together with the polyethylene tarp. Stretchable and easy-to-attach straps secure the mesh net tarp around the cargo by using a configuration of hooks at one or both ends of the strap for attaching anywhere into the woven mesh net tarp. The combination of mesh net tarp and the straps with hooks allow the mesh net to be pulled taut easily and simply by the straps to cover any configuration of cargo being transported.

### CROSS REFERENCE TO RELATED APPLICATION

This application claims the benefit of U.S. Provisional Patent Application No. 63/027,840 filed on May 20, 2020, which is incorporated by reference herein.

### FIELD OF THE INVENTION

This invention relates to a cargo cover and strap system for covering cargo, and in particular to a mesh net and straps that attach anywhere on the mesh net and to a vehicle.

### BACKGROUND OF THE INVENTION

Pickup trucks, trailers, and sport utility vehicles (SUV) are designed for carrying cargo whether in the bed of a pickup truck, on the bed of the trailer, or on top of the SUV. The cargo would be exposed to high winds and other weather elements when it is not covered by polyethylene tarps or cloth tarps. Polyethylene tarps or polytarps are the most common type of cargo tarps that are used to cover the exposed cargo because they are cheap. However, polyethylene tarps are prone to puncturing, shredding, folding, flapping and deteriorating when subject to high winds, sun, heat, rain and other weather-related conditions when traveling over distances at normal speeds.

Most polytarps have a core of woven polyethylene which is coated with polyethylene on both sides which makes them relatively tear-resistant. However, such polytarps are prone to puncture easily and once punctured such polytarps have a tendency to shred quickly. The polyethylene coating makes them initially waterproof, but through normal use, they develop wrinkles and fold lines which has a tendency to allow moisture to penetrate through the tarp. Polytarps also are not durable and are unable to handle much wear and tear.

Polytarps are unable to withstand even moderate winds of more than a few miles per hour for very long. When used to cover cargo loads on vehicles that travel at highway speeds, the air flowing over them causes flapping. This flapping causes wear and tear of the polyethylene coating. This leaves the woven core exposed and renders the tarp useless. When the tarp is securely tied down, it is virtually impossible to completely eliminate the flapping caused by airflow hitting the tarp directly as well as flowing over and around the load. The wind over the smooth surface of the tarp causes a laminar airflow over the surface of the plastic. Since the load that the tarp is covering is inherently uneven, this airflow causes low pressure areas that tug on the tarp to create the flapping. Even when the flaps created by folding the tarp tightly around the load are themselves taped down, eventually the tarp will work loosen and the tarp will shred.

Additionally, all polytarps suffer from the inherent limitation of tie down points. Typically, grommets are placed at all the corners of the polytarp and approximately every two feet along the edges of the polytarp. Sometimes, grommets are needed other than in the corners and along the edges. Typically, bungee cords or rope are used to tie the tarp over the load and attach it to a vehicle. It is impossible to pull the tarp taut everywhere to eliminate any buckling of the tarp between the grommets. The buckling areas become wear points that will quickly destroy the tarp. The same is true for the tarp where it wraps around corners.

These are common problems for all tarps used for cargo covers regardless of the materials they are made of, or the quality of those materials. There is a need for a cargo cover and strap system that overcomes the problems of puncturing, shredding, folding, flapping and deteriorating associated with polyethene tarps.

### SUMMARY OF THE INVENTION

It is an advantage of the invention to provide a cargo cover and strap system for covering cargo in or on a vehicle to prevent puncturing, shredding, folding, flapping and deteriorating when subject to high winds, sun, heat, rain and other weather-related conditions when transporting such cargo.

It is another advantage of the invention to layer two tarps on each other, where a first tarp is made of waterproof polyethene and the second tarp is made of a mesh net which lays on top of the first tarp.

It is yet another advantage of the invention to provide a cargo cover and strap system where an upper layer mesh net tarp is used to keep air flowing over the two layers of tarps to eliminate flapping and shredding of the tarps.

It is yet another advantage of the invention to provide a cargo cover and strap system where an upper layer mesh net tarp is used to reduce the deterioration of the tarps, giving them prolonged use over the years.

It is another advantage of the invention where straps can be hooked anywhere on the mesh net tarp making it the easiest way to secure the tarps on the cargo without just using the grommets around the edges.

It is an advantage of the invention to provide a flexible and adjustable strap that makes it easy to pull the mesh net tarp taut everywhere to eliminate any buckling and flapping of the tarp.

It is another advantage of the invention to provide an elastic strap that can be placed anywhere on the mesh net tarp.

It is an object of the invention to provide a cargo cover and strap system, comprising: a first tarp; a mesh net tarp having a woven polyethylene net, the second tarp capable of being placed on top of the first tarp; and a plurality of straps, each strap having a plurality of hooks on at least a first end, wherein the hooks of the straps are capable of fastening anywhere into the mesh net tarp.

It is another object of the invention to provide a cargo cover and strap system, comprising: a mesh net tarp having a woven net with some level of shade; and a plurality of straps, each strap having a plurality of hooks on a first end, where the hooks are capable of being inserted anywhere into the mesh net tarp.

It is yet another object of the invention to provide a cargo cover and strap system for a vehicle having a plurality of anchors, comprising: a polyethylene tarp having a grommet in each corner of the tarp; a mesh net tarp having some level of shade and having a grommet in each corner of the second tarp, the mesh net tarp capable of being placed on top of the polyethylene tarp; and a plurality of first straps, each strap having a plurality of hooks on a first end and a hook on a second end, where the hooks are capable of being inserted anywhere into the mesh net tarp and the hook is capable of being inserted through the grommet of the polyethylene tarp and the grommet of the mesh net tarp and into an anchor.

Although the invention is illustrated and described herein as embodied in a cargo cover and strap system, it is nevertheless not intended to be limited to the details shown, since various modification and structural changes may be made therein without departing from the spirit of the invention and within the scope and range of equivalents of the claims.

### BRIEF DESCRIPTION OF THE DRAWINGS

FIG. 1 illustrates a cargo cover and strap system according to an embodiment of the present invention.

FIG. 2 illustrates a strap having a grommet and plurality of hooks at one end and a hook at the other end according to an embodiment of the present invention.

FIG. 3 illustrates a strap having a grommet and plurality of hooks at each end according to an embodiment of the present invention.

FIG. 4 illustrates two halves of a grommet according to an embodiment of the present invention.

FIG. 5 illustrates an anchor plate according to an embodiment of the present invention.

### DETAILED DESCRIPTION OF THE INVENTION

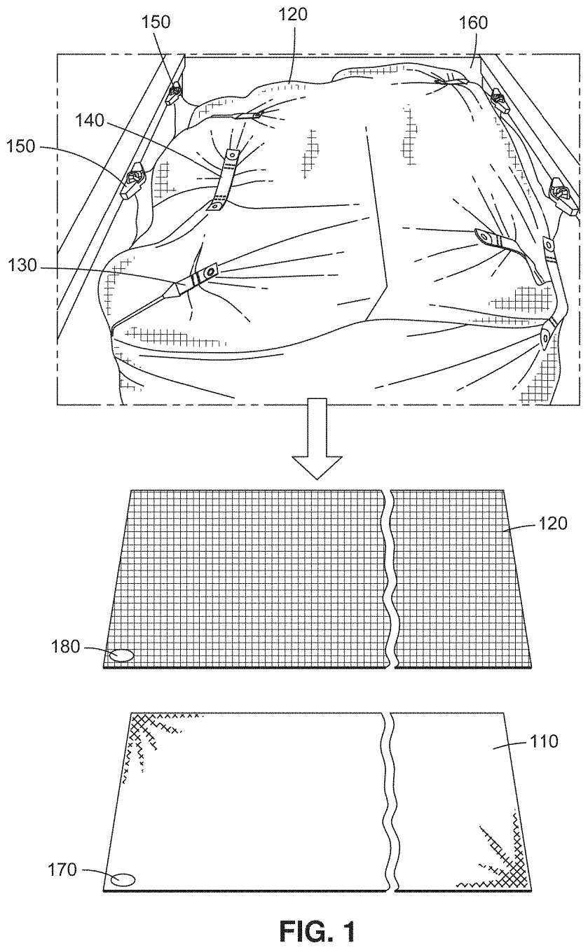

FIG. 1 illustrates the cargo covering and strap system 100 according to an embodiment of the present invention. As shown in FIG. 1, the cargo covering and strap system 100 comprises a first polyethene tarp 110, a mesh net tarp 120 which is layered on top of the first tarp 100, and straps 130, 140 where some ends of the straps 130, 140 attach, connect, couple or fasten anywhere on the mesh net tarp 120. For straps 130, the other end attach, connect, couple or fasten to anchors 150 or similar attachments embedded into a vehicle 160, or to other fasteners or to each other. For straps 140, both ends attach, connect, couple or fasten anywhere on the mesh net tarp 120 to make the mesh net tarp 120 taut around the cargo.

The first tarp 110 can be a solid piece of polyethylene material, canvas, denim, or any other type of cloth, plastic or polyethylene materials. The first tarp may have a core of woven polyethylene that is coated with polyethylene on both sides. The first tarp 110 is used as a weather proof and/or waterproof layer for protecting the cargo during transport from primarily rain, mud or other weather-related elements. The first tarp 110 may be of any size and shape but is preferably big enough to cover the cargo being transported. The first tarp 110 is the first tarp layer put over and around the cargo. The edges of the first tarp 110 can be tucked underneath the cargo or secured to the vehicle 160.

The first tarp 110 may have grommets 170 on each corner and at different places along the edges and may optionally have additional grommets along the edges of the first tarp 110, for example, a grommet every foot along the edge. The grommets 170 can be snapping grommets so that different tarps can be fastened together by a male-female attachment, or the grommets can be used for securing the tarp into anchors 150 inside a vehicle 160.

The mesh net tarp 120 is made from some type of tear resistant, durable, strong mesh net and is layered on top of the first tarp 110. The shade percentage or shade factor is the amount of shade that the mesh net tarp 120 produces. This is referred herein as a shade percentage factor or shade factor. The higher the shade factor or percentage, the less sunlight is allowed through. For a mesh tarp 120 having a 50% shade factor, this means that 50% of the sunlight is let through the mesh net tarp 120 while the remaining 50% is blocked. For a mesh tarp 120 having a 70% shade percentage or factor, the mesh net tarp 120 blocks 70% of the sunlight, allowing 30% of the sunlight through the mesh net tarp 120. The mesh net tarp 120 may provide no shade or may have some level of shade, where the shade protection is preferred around 60-85%. There is no requirement that the mesh net provide any level of shade. The mesh net tarp 120 is made to allow hooks to grab the mesh net tarp 120 or inserted into the mesh net tarp 120.

The mesh net tarp 120 is durable and strong, made with polyethylene material. The mesh net tarp 120 optionally can be UV resistant, tear resistant, mildew resistant and acid resistant. The mesh net tarp 120 is typically a woven mesh or sunshade cloth product that is made with ultraviolet light resistant materials to give it long life when exposed to direct sunlight.

The mesh net has a woven grid pattern where there are holes in the mesh net to allow airflow through the material. The mesh net tarp 120 will protect and stop the first tarp 110 from flapping in the wind by breaking up the air flow. The mesh net tarp 120 will prevent the first tarp 110 from shredding and deteriorating. The holes in the mesh net tarp 120 are throughout the tarp 120 and are where the hooks in straps 130, 140 connect, fasten, couple or attach into the mesh net tarp 120.

The mesh net tarp 120 may have the same size and shape of the first tarp 110, or it may have a different size and shape. The mesh net tarp 120 may be woven and made of a puncture-resistant and rip-resistant woven polyethylene mesh material, similar to that found in products for sunshade products. Optionally, wire or metal fibers may be combined with the polyethylene material to make the mesh net tarp 120 strong and more durable. Other materials could be used as well, including different types of cloths, canvases, denim and any other durable materials. The mesh net may have any type of grommets 180 (including snapping grommets) on each corner and at different places along the edges of the mesh net tarp 120.

The mesh net tarp 120 breaks up the air flow passing over first tarp 110. By adding the mesh net tarp 120 on top of the first tarp 110, this configuration keeps the first tarp 110 from flapping in the wind during transport. The straps 130, 140 provide a way to tie down the mesh net tarp 120 and the extra folds in the mesh net tarp 120 by attaching, coupling, fastening, joining anywhere to the mesh net tarp 120.

In an alternative embodiment, the first tarp 110 and mesh net tarp 120 may be combined into one layer of material, where one side of the tarp is a water-proof polyethylene material, and on the other side of the tarp, the mesh net material. The solid waterproof polyethylene tarp on one side (i.e., the bottom side) and a mesh net on the other side (i.e., the top side) may optionally have snapping grommets on each corner and at different places along the edges.

The tarp 110 and mesh net 120 is preferred to be used together, however mesh net 120 can be used by itself with straps 130 and/or straps 140. Tarp 110 can be used exactly as any other waterproof or water-resistant product available on the market today, especially when water protection is desired. The mesh net 120 or woven tarp layer 120 can be used for heavy and/or bulky loads, or loads with sharp or spiky cargo like construction debris, branches and/or tree limbs where parts of a polytarp would be otherwise be destroyed and where water protection was not necessary. When used together, the two layers provide all the benefits of the separate layers individually but also provides exceptional performance under very windy conditions or when used at high speeds on highways.

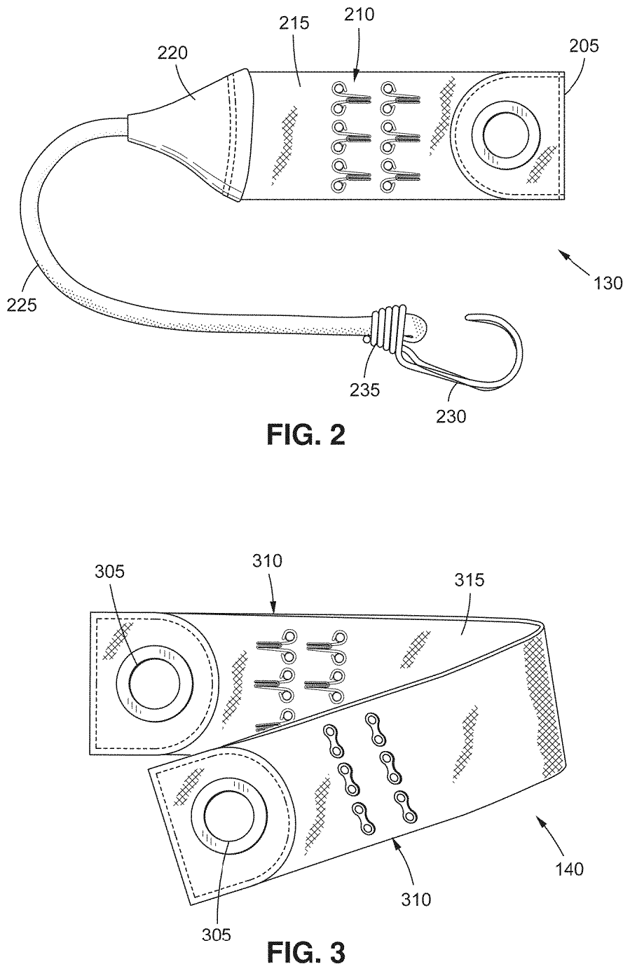

FIG. 2 shows strap 130 according to an embodiment of the present invention. The strap 130 has two ends, where one end has a grommet 205 and rows of hooks 205 fastened into a piece of material 215. The piece of material 215 is joined 220 to a bungee cord 225. The other end of the strap 130 is a hook 230 which is joined at 235 to the bungee cord 225.

The grommet 205 can be any size or shape of any commercially available grommet such as an interconnecting or snapping grommet. The grommet 205 is sewn or pressed into the piece of material 215 as shown in FIG. 2. The grommet 205 can be attached to the piece of material 215 using any method known by those skilled in the art. The grommet 205 is optional and strap 130 may not have a grommet 205.

As shown in FIG. 2, strap 130 has two rows of hooks 210, where three hooks 210 are used in each row. Each hook 210 is attached to the piece of material 215 by sewing, riveting or any other means for securely and durably fastening the hook 210 to the piece of material 215. The hooks 210 make it easy to fasten the strap 130 anywhere in or into the mesh net tarp 180. The number of hooks 210 and the number of rows can vary, for example, 3×3 (3 rows, each row having 3 hooks), 3×4 (3 rows, each row having 4 hooks). Moreover, the configuration of the hooks 210 can be something other than rows of hooks 210. For example, the configuration may have a first row and a third row each having three hooks 210 and in between the first row and the third row, the second row of hooks 210 would have two hooks 210 interspersed with alignment of the hooks 210 in the first and third rows. The hooks 210 may also be attached to an elastic material, a non-elastic material or a rigid material.

The angle of the hooks 210 can be a wrap-around hook as shown in FIG. 2. Alternatively, the hook can be formed from any angle between 1° and 90°. The end of the hook 210 that is inserted into mesh net tarp 180 may be pointed so it can easily slide in and out of mesh net tarp 180. The hook 210 can be made of any durable material, such as metal or plastic.

Material 215 may be made from elastic polyethene, but can be made from rubber, latex, canvas, denim, cloth, or any other type of durable material that can withstand weather and wind related conditions associated with transporting cargo. Material 215 can be made of elastic, a stretchable material, a rigid material, or a combination or elastic and rigid materials.

Material 215 joins, attaches, connects or couples 220 the material 215 to a bungee cord 225. This connection 220 is durable and strong to hold the bungee cord 225 to the material 215. The connection may be sewn as shown in FIG. 2, but can also be riveted, crimped with metal fasteners or joined together through any means or process known by those skilled in the art.

Bungee cord 225 attaches, connects, couples or joins to a typical bungee hook 230 at the other end of strap 130. The size and shape of the elastic material 215, bungee cord 225 and hook 230 can vary from what is shown in FIG. 2, meaning the material 215, bungee cord 225 and hook 230 can be longer, shorter, wider or less wide than shown in FIG. 2. In an alternative embodiment, there may be more than one bungee cord 225, such as two bungee cords 225, each having a hook 230 at the end. In another alternative embodiment, a durable clip could be used instead of the hook 230. Optionally, bungee cord 225 can be any type or non-stretchable or stretchable rope or elastic material.

Strap 130 makes securing the tarp 170 and mesh net tarp 180 into a vehicle, trailer or other structure simple and easy. The hook 230 of strap 130 can be fastened to an anchor 150 (FIG. 1) and by pulling on the elastic end 215, the strap 130 can be stretched and secured by hooking the hooks 210 anywhere into the mesh net tarp 180. The hooks 210 can easily be removed from the mesh net tarp 180, pulled and re-secured into a different part of the mesh net tarp 180. Strap 130 is unique in that the many small hooks 210 attach anywhere into the mesh net tarp 180, making it the easiest way to secure the tarps 170, 180 to and around the cargo that is being transported.

FIG. 3 shows a strap 140 having a plurality of rows of hooks 205 at both ends according to an embodiment of the present invention. At each end of strap 140, there is a grommet 305 and rows of hooks 310. Optionally, strap 140 may not have a grommet 305 at one or both ends. The grommet 305 on each ends of the strap 140 be any type of commercially available grommet including interconnecting or snapping grommets. Alternatively, the strap 140 at each end may have no grommet or multiple grommets.

Strap 140 is made of some type of elastic material 315 but also can be any other type of durable material such as stretchable material, a rigid material and/or combination of elastic and rigid materials. The size and shape of elastic strap 140 can vary from what is shown in FIG. 3, meaning strap 140 can be longer, shorter, wider or less wide than shown in FIG. 3.

On each end of strap 140, below the grommet 305, are rows of hooks 310 where each row has three hooks 310. The number of hooks 310, the number of rows of hooks 310 and then configuration or arrangement of the hooks 310 can vary from those shown in FIG. 3. The hooks 10 are capable of being attached, connected, hooked onto or coupled anywhere into the mesh net tarp 180.

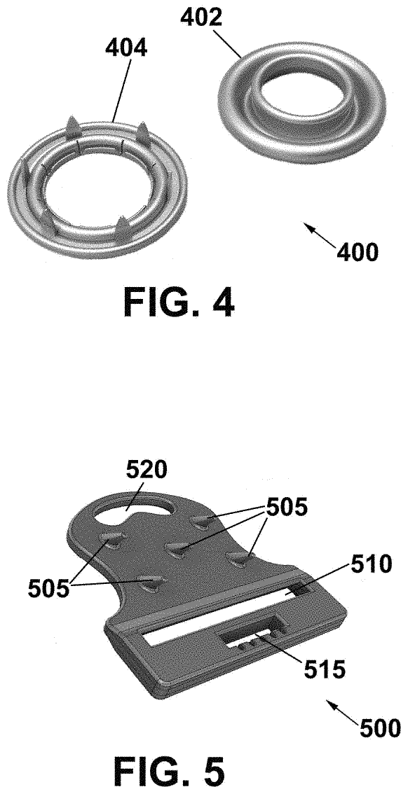

FIG. 4 shows the two halves of a snapping grommet 400 according to an embodiment of the present invention. FIG. 4 shows a male part 402 and a female part 404. The snapping grommet 400 joins, attaches, connects, snaps into, couples together the male part 402 and the female part 404. Snapping grommets 400 can be used to attach, connect or couple the first tarp 170 to the mesh net tarp 180. It is preferred that the snapping grommets 400 on the mesh net tarp 180 match the location of the snapping grommets 400 on the first tarp 170 so that the two layers can be snapped together. These grommets 400 can be located at each corner of the tarp 170 and mesh net 180, along the edges, and if needed somewhere other the edges of the tarp 170 and mesh net 180, such as for example, in the center or in the grid pattern. A snapping grommet comprises a female portion and a male portion, where the female portion snaps. rotates and/or joins the male portion to form a secure connection between the tarp 110 and the mesh net 120.

The snapping grommet 170, 180 is designed with a female receptacle on one side and a male ring on the opposite side. The two halves are pressed together with the tarp or netting material between them. Once the snapping grommet is attached to the material, this design allows the snapping grommets to be mated together, male side of one snapping grommet into the female side of another snapping grommet, to fasten multiple layers of the tarp materials together. With this design, there is no limit as to how many layers can be fastened together. Additionally, the snapping grommets can be used to extend the tarps or netting materials along any of the four edges. This allows tarps of standard sizes to be extended in both width and length to meet the user's size needs while reducing inventory items and costs. Finally, with a snapping grommet in the middle of the tarp 170, the snapping grommet can be used to secure the tarp with standard bungee style tiedowns, rope, etc., or with our custom tiedown straps.

FIG. 5 shows an anchor plate 500 according to an embodiment of the present invention. The anchor plate 500 is plastic, metal or any other type of durable material known by those skilled in the art. Anchor plate 500 comprises hooks 505, strap holes 510, 515, 520. As shown in FIG. 5, this embodiment shows an injected molded plastic piece with hooks 505 coming out on one surface of the anchor plate 500.

As shown in FIG. 5, hooks 505 have a wide base that tapers off toward the end. The end of each hook 505 is flat rather than pointed. The hooks 505 are molded in the plastic in this embodiment. The arrangement of the hooks 505 are two hooks 505 in two of the rows and a single hook 505 in the middle. Any configuration and number of the hooks in this anchor plate 500 (and straps 130, 140) are possible. In addition, the some of the hooks could have various lengths such as for example, a row of hooks 505 may be longer than hooks 505 on a different row. The hooks 505 also may protrude in different directions to grab the mesh net tarp and prevent the hooks 505 from falling out.

Rigid or elastic straps, ropes or other material are inserted into and around strap holes 510, 515, 520 in the anchor plate 500. For example, a piece of elastic material can be inserted through and in strap hole 510 and then sew one end of the material to another part of the material to securely hold the material to the anchor plate 500. The material or strap that fits into the strap holes 510, 515, 520 may be adjustable or fixed length.

This invention eliminates flapping and the associated deterioration of the underlying polytarp layer caused by wind or airflow over the load. The woven mesh net disturbs the laminar airflow that normally occurs over the load by creating a thin layer of air within the woven mesh above the polytarp. This air layer prevents the development of low-pressure regions directly above the polytarp and thus, prevents the tarp from flapping in the wind. By eliminating flapping of the underlying polytarp and providing ultraviolet light protection, long term usefulness can be achieved from low cost polytarps. The straps 130, 140 provides a way and method to pull slack out of the tarp to wrap objects tighter and add additional prevention against flapping. The tie downs provide a means to anchor any part of the tarp with bungee cords or rope, or any other means, by being able to attach the tie downs anywhere on the mesh tarp layer. Additionally, the tie downs provide a means to fold the tarp back onto itself.

Although exemplary embodiments have been shown and described, one of ordinary skill in the art may make many changes, modifications and substitutions without necessarily departing from the spirit and the scope of the invention. As for the specific terminology used to describe the exemplary embodiments, it is not intended to limit the invention. Each specific term is intended to include all technical equivalents that operate in a similar or substantially similar manner to accomplish a similar or substantially similar purpose or function.

For example, there are alternative embodiments of the invention to fasten the tarp 170 to the mesh net 180, including for example, using a hook and loop fasteners, clips, clamps, Velcro and/or other devices known in the art. The tarp 170 and mesh net 180 can be temporarily attached to each other by means of the hook fastener material that is permanently affixed to various small areas of the tarp. Additionally, a lock can be used with the tarp/mesh net, where the shackle or shank fits through the grommet in the tarp and/or mesh net through a hole in trailer/flatbed truck to secure the tarp and mesh net to the trailer/flatbed truck. Alternatively, a wire can be inserted through the hole in the grommet, where the wire has a loop at each end, and where a locking mechanism (e.g., lock and key) can be used to prevent loss of tiedown.

What is claimed is:

1. A cargo cover and strap system, comprising:
a first tarp;
a mesh net tarp having a woven polyethylene net, the second tarp capable of being placed on top of the first tarp; and
a plurality of straps, each strap having a plurality of hooks on at least a first end, wherein the hooks of the straps are capable of fastening anywhere into the mesh net tarp.

2. A cargo cover and strap system as in claim 1, wherein the first tarp is made of waterproof polyethene.

3. A cargo cover and strap system as in claim 1, wherein the mesh net tarp comprises a woven material that allows airflow through the woven material.

4. A cargo cover and strap system as in claim 1, wherein the first tarp includes a male part of a grommet and the mesh net tarp includes a female part of a grommet, the male part being capable of snapping into the female part to join the first tarp to the mesh net tarp.

5. A cargo cover and strap system as in claim 1, wherein the first tarp includes a female part of a grommet and the mesh net tarp includes a male part of a grommet, the female part being capable of snapping into the male part to join the first tarp to the mesh net tarp.

6. A cargo cover and strap system as in claim 1, wherein the hooks at one end of each strap is configured into at least one or more rows, each row having at least one hook.

7. A cargo cover and strap system as in claim 1, wherein the strap is comprised of:
a piece of material;
the hooks attached to the piece of material;
a bungee cord attached to the piece of material; and
a hook attached the bungee cord.

8. A cargo cover and strap system as in claim 1, wherein the strap is comprised of:
a piece of material;
a grommet attached at the end of the piece of material;
the hooks attached to the piece of material by the grommet;
a bungee cord attached to the piece of material; and
a hook attached the bungee cord.

9. A cargo cover and strap system as in claim 1, wherein the strap is comprised of:
a piece of material; and
the hooks attached to the piece of material at both ends of the piece of material, the hooks being configured into at least one or more rows, where each row has one or more hooks.

10. A cargo cover and strap system as in claim 1, wherein the strap is comprised of:
a piece of material;
a grommet at each end of the piece of material; and
the hooks attached to the piece of material at both ends of the piece of material next to the grommet.

11. A cargo cover and strap system as in claim 1, wherein the strap is elastic and stretchable, and wherein the hooks are capable of hooking into the mesh net tarp.

12. A cargo cover and strap system, comprising:
a mesh net tarp having a woven net having some level of shade; and
a plurality of straps, each strap having a plurality of hooks on a first end, where the hooks are capable of being inserted anywhere into the mesh net tarp.

13. A cargo cover and strap system as in claim 12, further comprising a first polyethene tarp, wherein the mesh net tarp is capable of being layered on top of the first tarp.

14. The cargo cover and strap system of claim 12, wherein the hooks at one end of each strap is configured into at least one or more rows, each row having one or more hooks.

15. A cargo cover and strap system as in claim 12, wherein the strap is comprised of:
a piece of material;
the hooks attached to the piece of material;
a bungee cord attached to the piece of material; and
a hook attached the bungee cord.

16. A cargo cover and strap system as in claim 12, wherein the strap is comprised of:
a piece of material;
a grommet attached at the end of the piece of material;
the hooks attached to the piece of material by the grommet;
a bungee cord attached to the piece of material; and
a hook attached the bungee cord.

17. A cargo cover and strap system as in claim 12, wherein the strap is comprised of:
a piece of material; and
the hooks attached to the piece of material at both ends of the piece of material, the hooks being configured into at least one or more rows, where each row has one or more hooks.

18. A cargo cover and strap system as in claim 12, wherein the strap is comprised of:
a piece of material;
a grommet at each end of the piece of material; and
the hooks attached to the piece of material at both ends of the piece of material next to the grommet.

19. A cargo cover and strap system for a vehicle having a plurality of anchors, comprising:
a polyethylene tarp having a grommet in each corner of the tarp;
a mesh net tarp having a grommet in each corner of the second tarp, the mesh net tarp capable of being placed on top of the polyethylene tarp, the mesh net tarp having holes where air is capable of passing through the mesh net tarp; and
a plurality of first straps, each strap having one or more hooks on a first end and a hook on a second end, where the one or more hooks are capable of being inserted anywhere into the mesh net tarp and the hook is capable of being inserted through the grommet of the polyethylene tarp, through the grommet of the mesh net tarp and through an anchor.
